(19) United States
(12) Patent Application Publication
(10) Pub. No.: US 2004/0259492 A1
(43) Pub. Date: Dec. 23, 2004

(54) Side defroster

(75) Inventors: Katsuaki Suzuki, Aichi-ken (JP); Yasuyuki Higuchi, Aichi-ken (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/854,143

(22) Filed: May 27, 2004

(30) Foreign Application Priority Data
Jun. 17, 2003 (JP) 2003-172261 (PAT.

(51) Int. Cl. B60S 1/54

(52) U.S. Cl. 454/124

(57) ABSTRACT

A side defroster includes an outlet, a duct, and a front-end corner member. The outlet is for blowing defogging air to a front side windshield. The duct demarcates a ventilation passage for leading the defogging air to the outlet. The front-end corner member neighbors a front end of the front side windshield, is provided with the outlet opened therethrough, and accommodates the duct therein. The side defroster little impairs the unity of interior decorations, exhibits a high defogging efficiency, and can secure a satisfactory air delivery rate for the defogging air.

### BACKGROUND OF THE INVENTION

1. Field of the Invention

The present invention relates to a side defroster for defogging a front side windshield.

2. Description of the Related Art

The outlet of a side defroster is opened at the opposite ends of an instrument panel in the vehicle widthwise direction or in a door trim panel. The outlet communicates with an air conditioner by way of a ventilation passage. Defogging air blowing out through the outlet defogs a front side windshield.

However, when the outlet is opened at the opposite ends of an instrument panel in the vehicle widthwise direction or in a door trim, the outlet might produce a disunified effect against interior decorations decoratively, and might make the appearance poor eventually. Moreover, the outlet is separated from the front side windshield relatively. Accordingly, the defogging air blowing out through the outlet might dissipate before it reaches the front side windshield. Consequently, the defogging efficiency is not necessarily high with respect to the net air delivery rate blowing out through the outlet.

Hence, Japanese Unexamined Patent Publication (KOKAI) No. 7-291,050 proposes a side defroster in which an outlet is opened in the pillar member of a door frame garnish surrounding a front side windshield. In the conventional side defroster set forth in the publication, the outlet is not noticeable. Accordingly, the outlet is less likely to cause the fear of impairing the unified effect of interior decorations. Moreover, the pillar member is disposed adjacent to the front side windshield. Consequently, defogging air blowing out through the outlet is less likely to dissipate before it reaches the front side windshield. Therefore, in the conventional side defroster, the defogging efficiency is high with respect to the net air delivery rate blowing out through the outlet.

However, in the conventional side defroster set forth in the publication, the outlet is disposed in the pillar member of the door frame garnish. The pillar member has a relatively small cross-sectional area. Accordingly, it is difficult to form a ventilation passage provided with a satisfactory cross-sectional area inside the pillar member. Namely, in the conventional side defroster, although the defogging efficiency is high with respect to the net air delivery rate blowing out through the outlet, the air delivery rate itself is relatively small. Consequently, it is difficult for the conventional side defroster to quickly defog the front side windshield.

### SUMMARY OF THE INVENTION

The present invention has been developed and completed in view of such circumstances. It is therefore an object of the present invention to provide a side defroster which little impairs the unity of interior decorations, which exhibits a high defogging efficiency, and which can secure a satisfactory air delivery rate for defogging air.

A side defroster according to the present invention can solve the aforementioned problems, and comprises:

an outlet for blowing defogging air to a front side windshield;

a duct demarcating a ventilation passage for leading the defogging air to the outlet; and

a front-end corner member neighboring a front end of the front side windshield, being provided with the outlet opened therethrough, and accommodating the duct therein.

The front-end corner member is used as a holder for holding the fastened end of a door mirror, for example. In the present side defroster, the outlet is opened in the front-end corner member.

The front-end corner member is disposed to neighbor the front side windshield. Accordingly, defogging air blowing out through the outlet is less likely to dissipate before it reaches the front side windshield. Consequently, the defogging efficiency is high with respect to the net air delivery rate blowing out through the outlet.

Further, the front-end corner member is less noticeable in vehicle passenger rooms than instrument panels and door trim panels. Accordingly, the front-end corner member is less likely to impair the unity of internal decorations.

Furthermore, the front-end corner member accommodates the duct provided with a relatively large air-delivery cross-sectional area therein. Consequently, it is possible for the present side defroster to secure a satisfactory air delivery rate for defogging air.

Moreover, it is often the case that a door mirror is disposed outside vehicle passenger rooms outward with respect to the front-end corner member. In order that drivers can recognize the door mirror, it is preferable to quickly defog parts of the front side windshield which are indispensable for drivers to recognize the door mirror, i.e., parts of the front side windshield neighboring the front-end corner member. In view of this, the present side defroster comprises the outlet opened in the front-end corner member. Accordingly, the present side defroster can quickly defog the parts of the front side windshield neighboring the front-end corner member. Thus, the present side defroster can offer drivers high door mirror visibility.

In addition, the side defroster set forth in Japanese Unexamined Patent Publication (KOKAI) No. 7-291,050 cannot be disposed in vehicles which are not equipped with any door frame garnish, such as hardtop vehicles. On the contrary, the present side defroster can be disposed in vehicles which are not equipped with any door frame garnish. Thus, the present side defroster can produce a versatile applicability.

The front-end corner member can preferably be formed integrally with a door frame garnish surrounding the periphery of the front side windshield. With such an arrangement, it is possible to assemble the present side defroster in vehicles, which are equipped with a door frame garnish, with ease relatively.

The present side defroster can preferably further comprise a deflector for deflecting the defogging air, the deflector disposed in the ventilation passage. With such an arrangement, it is possible to inhibit turbulent flows from occurring in the ventilation passage. As a result, the actual air delivery rate enlarges furthermore.

The duct can preferably be formed as a cylinder; and the ventilation passage can preferably be formed inside the cylinder. With such an arrangement, it is possible to enhance the airtightness at the ventilation passage, because the duct demarcates the ventilation passage independently.

The duct can preferably be formed as a partially cut-away cylinder; and the duct can preferably be covered with the inner surface of the front-end corner member, thereby demarcating the ventilation passage. With such an arrangement, the duct and the front-end corner member demarcate the ventilation passage. As a result, it is possible to form the duct with a reduced number of walls, compared with the case where the duct demarcates the ventilation passage independently.

The duct can preferably be independent of the front-end corner member; and the duct can preferably be assembled with the front-end corner member by at least one means selected from the group consisting of claw fitting and welding. With such an arrangement, it is possible to assemble the duct with the front-end corner member with ease relatively.

The duct can preferably be formed integrally with the front-end corner member. With such an arrangement, it is possible to construct the present side defroster with a reduced number of component parts, compared with the case where the duct and the front-end corner member are independent of each other.

In accordance with the present invention, it is possible to provide a noble side defroster which little impairs the unity of interior decorations, which exhibits a high defogging efficiency, and which can secure a satisfactory air delivery rate for defogging air.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective view of a driver's seat-side front door in which a side defroster according to Example No. 1 of the present invention is disposed.

FIG. 2 is a perspective view of a door frame garnish in which the present side defroster according to Example No. 1 is disposed, door frame garnish which is viewed from inside a vehicle passenger room.

FIG. 3 is a perspective view of the door frame garnish in which the present side defroster according to Example No. 1 is disposed, door frame garnish which is viewed from outside the vehicle passenger room.

FIG. 4 is an enlarged view of a major portion of the door frame garnish within the circle designated at “4” in FIG. 3.

FIG. 5 is a cross-sectional view taken along the arrows “5”-“5” of FIG. 4.

FIG. 6 is an exploded view of the present side defroster according to Example No. 1.

FIG. 7 is a cross-sectional view of a side defroster according to Example No. 2 of the present invention.

FIG. 8 is a perspective view of a side defroster according to Example No. 3 of the present invention.

FIG. 9 is a perspective view of a driver's seat-side front door in which a side defroster according to Example No. 4 of the present invention is disposed.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EXAMPLES

Hereinafter, the present invention will be described in detail with reference to specific examples.

### Example No. 1

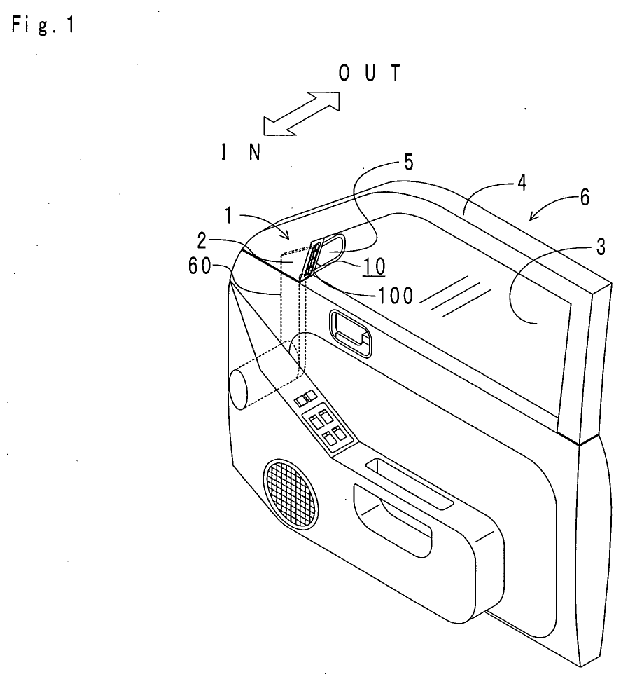

First, an arrangement of a side defroster according to Example No. 1 of the present invention will be described. FIG. 1 illustrates a driver's seat-side front door in which the present side defroster according to Example No. 1 is disposed. Note that the present side defroster according to Example No. 1 is also disposed in a navigator's seat-side front door. However, the present side defroster according to Example No. 1 disposed in the navigator's seat-side front door is arranged, operates and produces advantages in the same manner as the present side defroster according to Example No. 1 disposed in the driver's seat-side front door. Therefore, the present side defroster according to Example No. 1 disposed in the navigator's seat-side front door will not be described hereinafter.

As illustrated in FIG. 1, a side defroster 1 according to Example No. 1 of the present invention is disposed in a driver's seat-side front door. Specifically, the side defroster 1 is disposed in a front-end corner member 2 which is made of resin and is formed as a triangle-shaped box. Note that the front-end corner member 2 is formed integrally with a door frame garnish 4 which surrounds a front side windshield 3. On the outside surface of the front-end corner member 2 with respect to the vehicle passenger room, a door mirror 5 is disposed perpendicularly to the front-end corner member 2. Inside the driver's seat-side front door 6, a door duct 60 (shown with dotted lines in the drawing) is disposed. The door duct 60 communicates the side defroster 1 with an air conditioner (not shown in the drawing) which is disposed behind an instrument panel (not shown in the drawing). The air conditioner supplies defogging air to the side defroster 1 by way of the door duct 60.

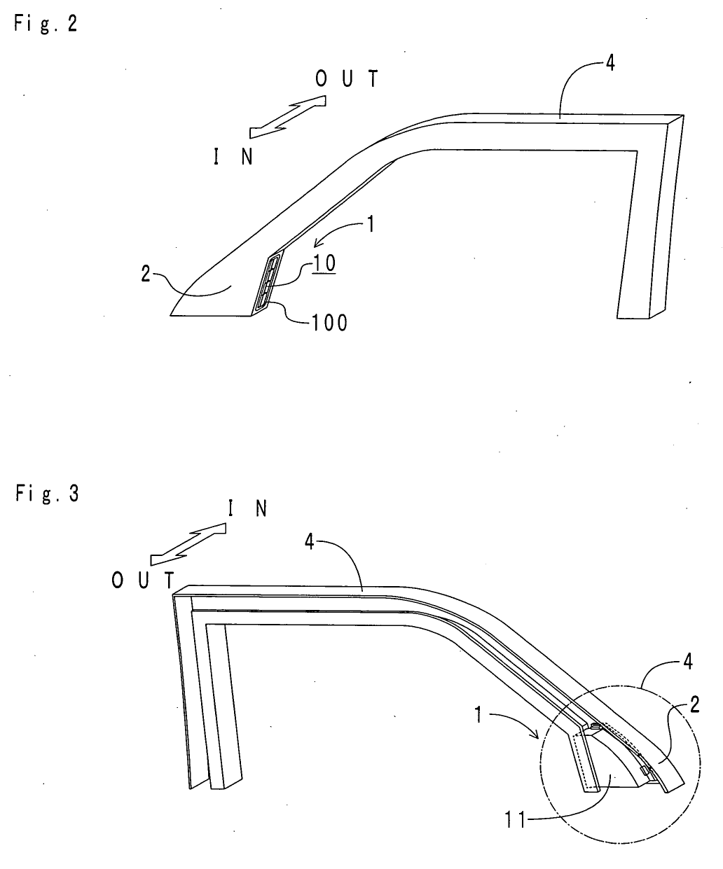

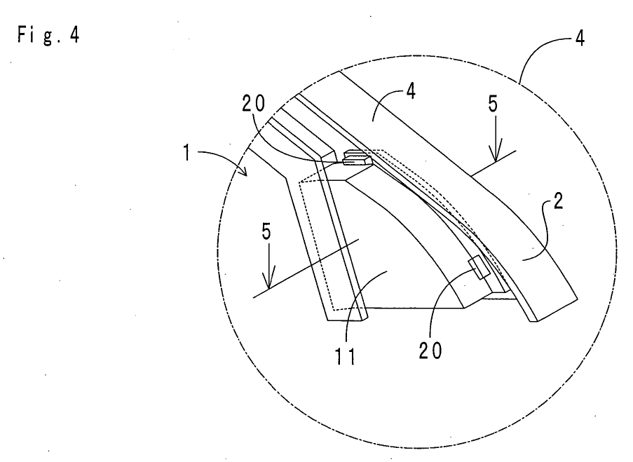

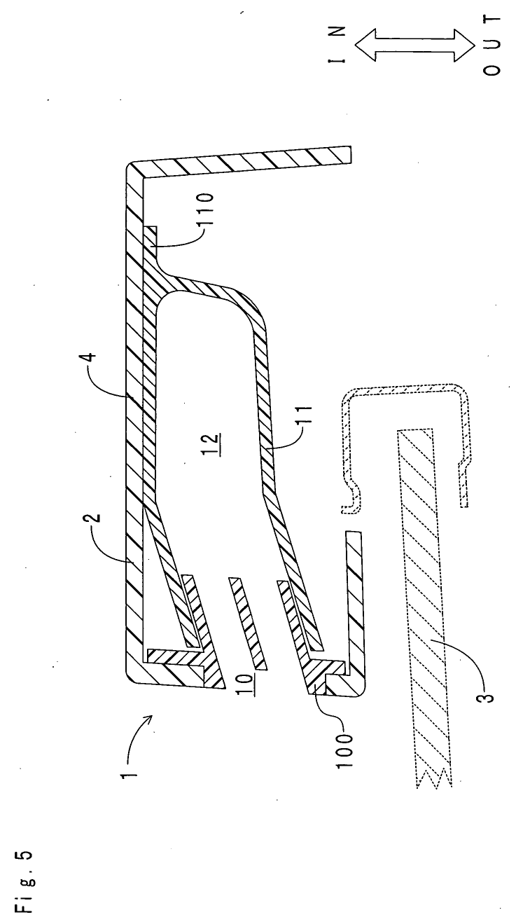

FIG. 2 illustrates a perspective view of the door frame garnish 4 in which the side defroster 1 according to Example No. 1 is disposed, door frame garnish 4 which is viewed from inside the vehicle passenger room. Further, FIG. 3 is a perspective view of the door frame garnish 4 in which the side defroster 1 according to Example No. 1 is disposed, door frame garnish 4 which is viewed from outside the vehicle passenger room. Furthermore, FIG. 4 illustrates an enlarged view of a major portion of the door frame garnish 4 within the circle designated at “4” in FIG. 3. Moreover, FIG. 5 illustrates a cross-sectional view taken along the arrows “5”-“5” of FIG. 4.

As illustrated in the drawings, the door frame garnish 4 is formed as a cross-sectionally dented shape which opens outward with respect to the vehicle passenger room. The side defroster 1 comprises an outlet 10, and a duct 11. As illustrated in FIG. 2, the outlet 10 is demarcated by a bezel 100. The bezel 100 is buried in the front-end corner member 2, and is made of resin. Thus, the outlet 10 is disposed adjacent to the front end of the front side windshield 3.

The duct 11 is made of resin, and is formed as a cylinder shape. As illustrated in FIG. 3, the duct 11 is disposed inside the front-end corner member 2. The duct 11 is connected with the door duct 60 (shown in FIG. 1) at the upstream end, and is connected with the bezel 100 at the downstream end. Inside the duct 11, a ventilation passage 12 (shown in FIG. 5) is demarcated. The defogging air is distributed in the following order: the air conditioner; inside the door duct 60; the ventilation passage 12; and the bezel 100; and eventually is blown onto the front end of the front side windshield 3 through the outlet 10.

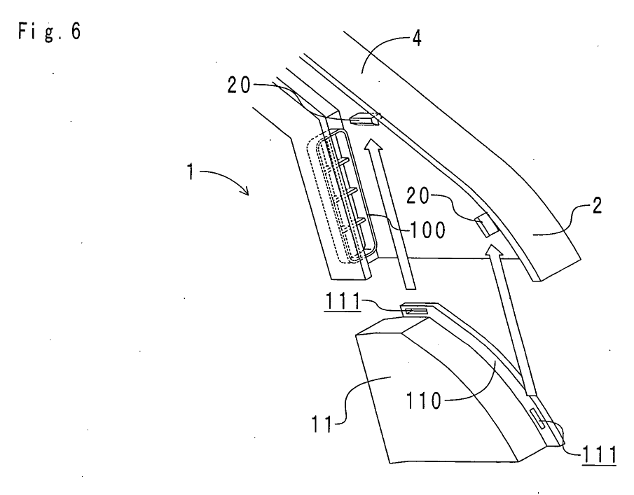

Next, how to assemble the side defroster 1 according to Example No. 1 will be hereinafter described. FIG. 6 illustrates an exploded view of the side defroster 1 according to Example No. 1. As illustrated in the drawing, an installation flange 110 is formed at the periphery of the duct 11. The installation flange 110 is provided with two fitting holes 111. On the other hand, two fitting claws 20 are projected from the inner surface of the front-end corner member 2 which is integral with the door frame garnish 4. When assembling the side defroster 1, the bezel 100 is first buried in the front-end corner member 2. Subsequently, the duct 11 is slid into the front-end corner member 2 as designated with the blank arrows of the drawing. Then, the fitting claws 20 are engaged with the fitting holes 111. By the engagement, the duct 11 is positioned with respect to the bezel 100. Thus, the ventilation passage 12 communicates with the outlet 10.

Then, how the side defroster 1 according to Example No. 1 produces advantages will be hereinafter described. The front-end corner member 2 is disposed adjacent to the front end of the front side windshield 3. Namely, the outlet 10 is in proximity to the front end of the front side windshield 3. Accordingly, the defogging air blowing out through the outlet 10 is less likely to dissipate before it reaches the front side windshield 3. Therefore, the defogging efficiency is high with respect to the net air delivery rate blowing out through the outlet 10.

Further, the front-end corner member 2 is less noticeable in the vehicle passenger room, compared with the instrument panel and the door trim panel. Accordingly, the front-end corner member 2 is less likely to cause the fear that it impairs the unity of internal decorations. Furthermore, the duct 11 with a comparatively large air-delivery cross-sectional area is accommodated inside the front-end corner member 2. Consequently, the side defroster 1 according to Example No. 1 can secure a satisfactory air delivery rate for the defogging air.

Moreover, the door mirror 5 is disposed outside the vehicle passenger room outward perpendicularly to the front-end corner member 2. Note that the side defroster 1 according to Example No. 1 can quickly defog parts of the front side windshield 3 which are indispensable for drivers to recognize the door mirror 5. Thus, the side defroster 1 can offer drivers high visibility to the door mirror 5.

In addition, the front-end corner member 2 is formed integrally with the door frame garnish 4. Accordingly, compared with the case where the front-end corner member 2 and the door frame garnish 4 are formed independently of each other, it is possible to construct the side defroster 1 according to Example No. 1 with a reduced number of component parts. Still further, the duct 11 demarcates the ventilation passage 12 independently. Consequently, the ventilation passage 12 exhibits enhanced airtightness. Still furthermore, the duct 11 is assembled with the front-end corner member 2 by claw fitting. Therefore, the duct 11 can be assembled with the front-end corner member 2 with ease relatively.

### Example No. 2

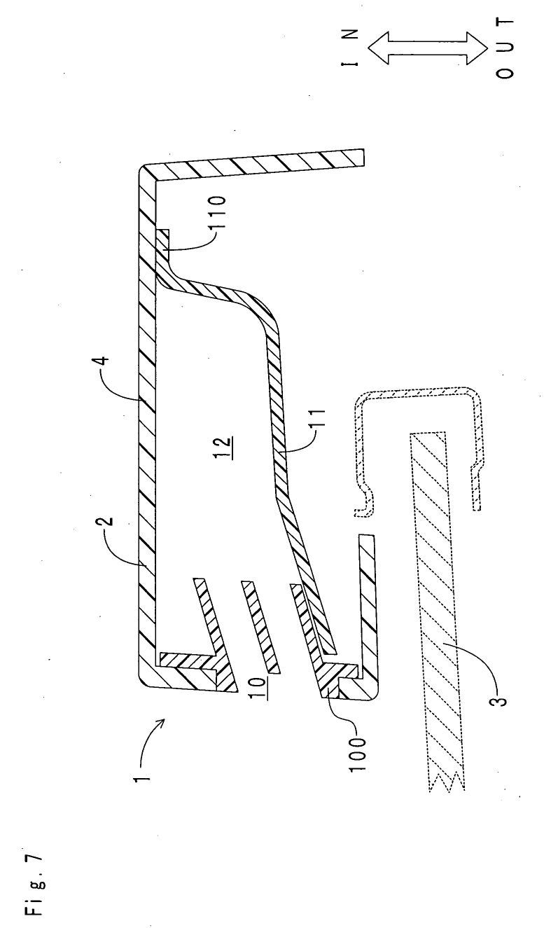

A side defroster 1 according to Example No. 2 of the present invention differs from the side defroster 1 according to Example No. 1 in that the duct 11 is formed as a partially cut-away cylinder. Therefore, only the difference will be hereinafter described. FIG. 7 illustrates a cross-sectional view of the side defroster 1 according to Example No. 2. In FIG. 7, note that parts like those of FIG. 5 are designated at the same reference numerals.

As illustrated in the drawing, the duct 11 is opened inward with respect to the vehicle passenger room. The duct 11 is assembled with the front-end corner member 2 in such a manner that the opening is covered with the inner surface of the front-end corner member 2. Thus, the ventilation passage 12 is demarcated by the inner surface of the duct 11 and the inner surface of the front-end corner member 2.

The side defroster 1 according to Example No. 2 produces advantages in the same manner as the side defroster 1 according to Example No. 1. Moreover, the side defroster 1 according to Example No. 2 can obviate the vehicle passenger room-side partition wall of the duct 11. As a result, it is possible to construct the duct 11 with a reduced number of walls.

### Example No. 3

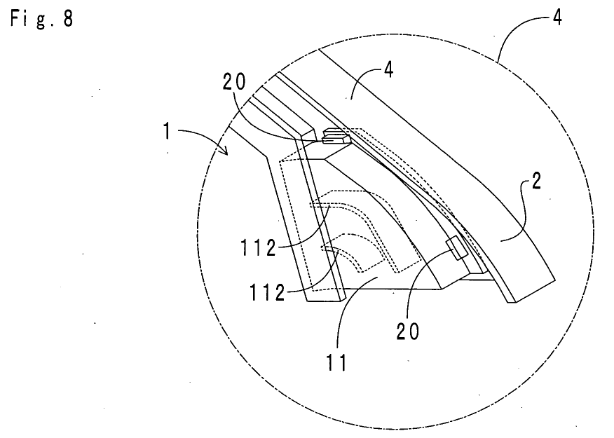

A side defroster 1 according to Example No. 3 of the present invention differs from the side defroster 1 according to Example No. 1 in that current plates are disposed in the ventilation passage 12. Therefore, only the difference will be hereinafter described. FIG. 8 illustrates a perspective view of the side defroster 1 according to Example No. 3. In FIG. 8, note that parts like those of FIG. 4 are designated at the same reference numerals.

As illustrated in the drawing, two current plates 112 are erected from the inner surface of the duct 11 toward the front-end corner member 2. Note that the current plates 112 are included in the deflector set forth in the appended claims. The two current plates 112 are disposed along the curved configuration of the duct 11.

The side defroster 1 according to Example No. 3 produces advantages in the same manner as the side defroster 1 according to Example No. 1. Moreover, the current plates 112 of the side defroster 1 according to Example No. 3 can make turbulent flows less likely to occur in the ventilation passage 12. As a result, the actual air delivery rate of the defogging air increases furthermore.

### Example No. 4

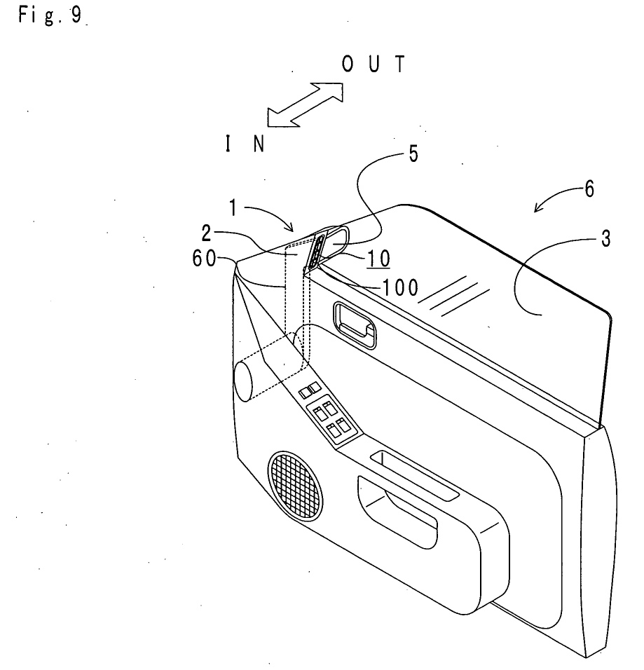

A side defroster 1 according to Example No. 4 of the present invention differs from the side defroster 1 according to Example No. 1 in that it is disposed in a hardtop vehicle. Therefore, only the difference will be hereinafter described. FIG. 9 illustrates a perspective view of a driver's seat-side front door 6 in which the side defroster 1 according to Example No. 4 is disposed. In FIG. 9, note that parts like those of FIG. 1 are designated at the same reference numerals.

As illustrated in the drawing, the driver's seat-side front door 6 is free from the disposition of the door frame garnish 4 shown in FIG. 1. Accordingly, the front-end corner member 2 is disposed independently in the driver's seat-side front door 6. The side defroster 1 according to Example No. 4 produces advantages in the same manner as the side defroster 1 according to Example No. 1.

### (Modified Versions)

Heretofore, a few of the embodiment modes of the present side defroster are described. However, the embodiment modes are not limited to the above-described embodiment modes particularly. It is possible to perform the present side defroster in various modified embodiment modes or improved embodiment modes which one of ordinary skill in the art can carry out.

For example, in the above-described examples, the front-end corner member 2 and the duct 11 are formed independently of each other, but they can be formed integrally. With the arrangement, not only the present side defroster can comprise with a reduced number of component parts, but also it can be assembled with ease. Further, in the above-described examples, the front-end corner member 2 and the duct 11 are assembled by claw fitting, but they can be assembled by the other means such as welding. Furthermore, in Example No. 3, the two current plates 112 are disposed as the deflector in the ventilation passage 2, but the shape and quantity of the deflector are not limited in particular. Moreover, the deflector can be formed integrally with the inner surface of the front-end corner member 2. In addition, in the above-described examples, the bezel 100 is disposed independently of the front-end corner member 2 as illustrated in FIG. 5, but the bezel 100 can be formed integrally with the front-end corner member 2. With the arrangement, the present side defroster can comprise with a reduced number of component parts.

Having now fully described the present invention, it will be apparent to one of ordinary skill in the art that many changes and modifications can be made thereto without departing from the spirit or scope of the present invention as set forth herein including the appended claims.

What is claimed is:

1. A side defroster, comprising:
an outlet for blowing defogging air to a front side windshield;
a duct demarcating a ventilation passage for leading the defogging air to the outlet; and
a front-end corner member neighboring a front end of the front side windshield, being provided with the outlet opened therethrough, and accommodating the duct therein.

2. The side defroster set forth in claim 1, wherein the front-end corner member is formed integrally with a door frame garnish surrounding the periphery of the front side windshield.

3. The side defroster set forth in claim 1 further comprising a deflector for deflecting the defogging air, the deflector disposed in the ventilation passage.

4. The side defroster set forth in claim 1, wherein the duct is formed as a cylinder; and the ventilation passage is formed inside the cylinder.

5. The side defroster set forth in claim 1, wherein the duct is formed as a partially cut-away cylinder; and the duct is covered with the inner surface of the front-end corner member, thereby demarcating the ventilation passage.

6. The side defroster set forth in claim 1, wherein the duct is independent of the front-end corner member; and the duct is assembled with the front-end corner member by at least one means selected from the group consisting of claw fitting and welding.

7. The side defroster set forth in claim 1, wherein the duct is formed integrally with the front-end corner member.
